(19) United States
(12) Patent Application Publication
(10) Pub. No.: US 2009/0200820 A1
(43) Pub. Date: Aug. 13, 2009

(54) Convertible pick up truck tent camper/lumber rack

(76) Inventor: Ernest Franklin Smith, JR., Fontana, CA (US)

Correspondence Address: ERNEST F. SMITH JR., 5392 FETLOCK AVENUE, FONTANA, CA, 92336, US

(21) Appl. No.: 12/069,459

(22) Filed: Feb. 11, 2008

(51) Int. Cl. B60P 3/39

(52) U.S. Cl. 296/3

(57) ABSTRACT

Many attempts have been made to create tent campers for pickup trucks but this is the first to create a lumber rack for a pickup truck that has the look and appeal of a lumber rack and which can be quickly converted to the framework of a tent camper that is exceptionally large and roomy providing off the floor sleeping areas as well as over the cab storage areas without additional framework which must be stored separately from the lumber rack framework.

### CROSS-REFERENCE TO RELATED APPLICATIONS

There are no claims of benefit of co-pending non-provisional applications (or international applications designating the United States of America) for this application.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

The inventor, wanting to spend time in the outdoors and participate in spur of the moment outdoor excursions, wished to have a truck camper that would be removable so that his truck could be used during the week for work purposes. The problems associated with truck campers are several. They are expensive, not easily removed from the truck and take up a parking space when not kept on the truck. After longing for a simple, yet relatively inexpensive solution to this need, the inventor came up with the idea of designing a tent that would fit on the pick up truck that would remain in place while allowing the truck to be utilized for the every day work purposes for which it was purchased. The following invention was born of this need and serves both purposes for which it was designed while remaining in place all of the time and allowing the lumber rack to be used during the week for work and quickly converted to a tent camper in a matter of minutes.

### BRIEF SUMMARY OF THE INVENTION

The invention described herein pertains to the outdoor enthusiast who has occasion to take trips into the wilderness or desert for short duration outdoor activities. The convertible tent camper is readily erected from the lumber rack which remains on the pick tip truck during times of non use. The lumber rack serves the purpose of a well designed lumber rack and remains in place always available for short week-end forays easily converted to a tent camper that can sleep two to four people comfortably. An additional benefit of the design allows other camping, fishing and outdoor equipment to remain in the bed of the truck or over the cab while occupied with two to three adult campers. The sleeping arrangements are not on the bed of the truck they are on the two fold out platforms and over the cab extension similar to what you would see in the more expensive hard body campers. The total deck area including truck bed and bunks is approximately 90 square feet when full extended.

### BRIEF DESCRIPTION OF THE SEVERAL VIEWS OF THE DRAWING

FIG. 1A—This figure shows a perspective view of the frame fully extended with the tent cover installed.

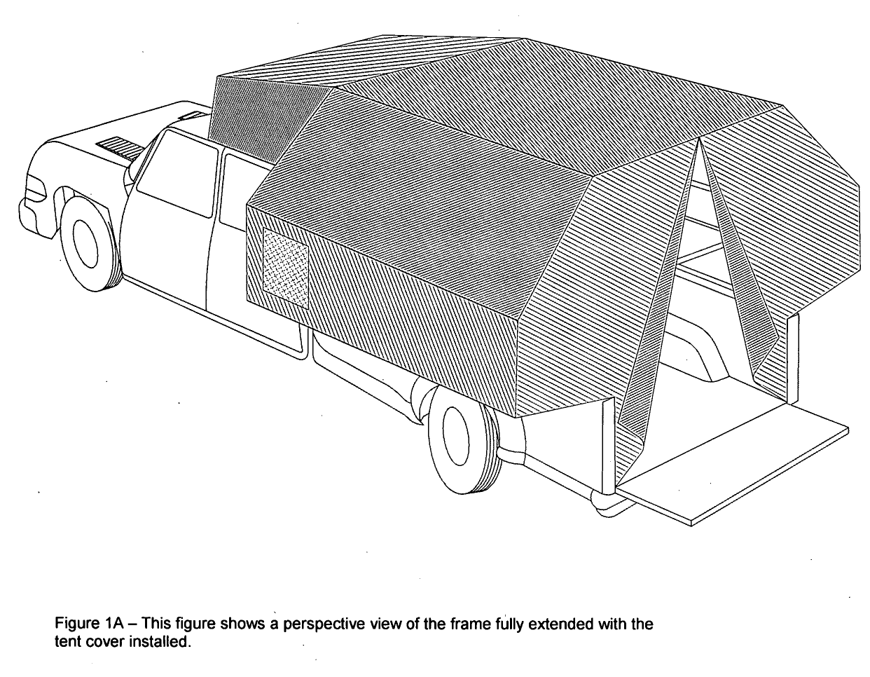

FIG. 2A—This figure shows a side view of the lumber rack that is fully retracted and in use as a lumber rack.

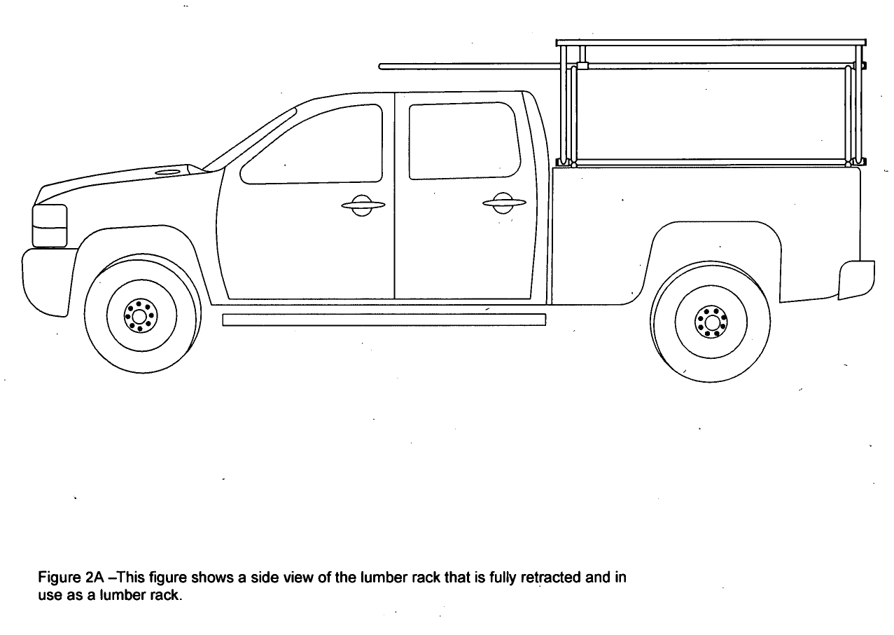

FIG. 3A—This figure shows a back view of the tent camper with the lumber rack extended to support the canvas tent.

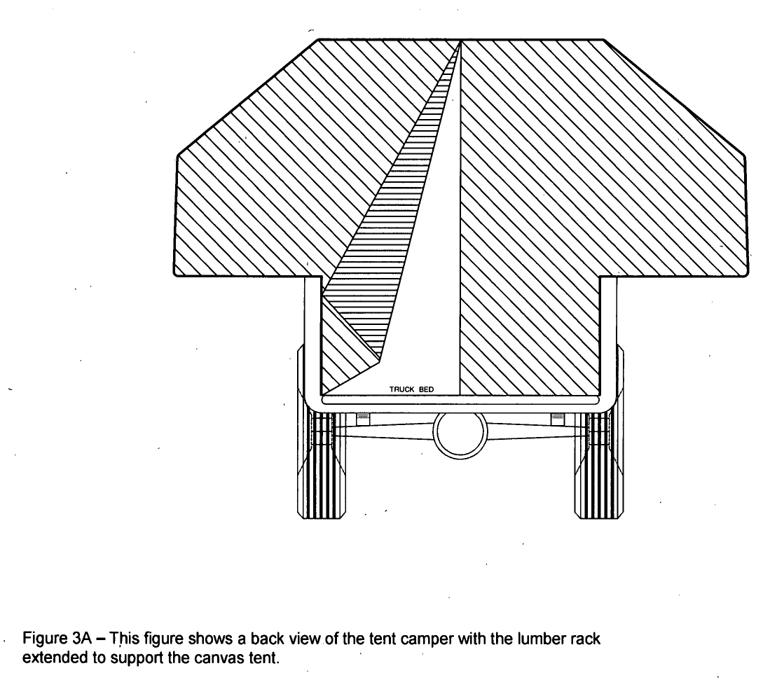

FIG. 4A—This figure shows a side view of the tent camper with the lumber rack extended to support the canvas tent.

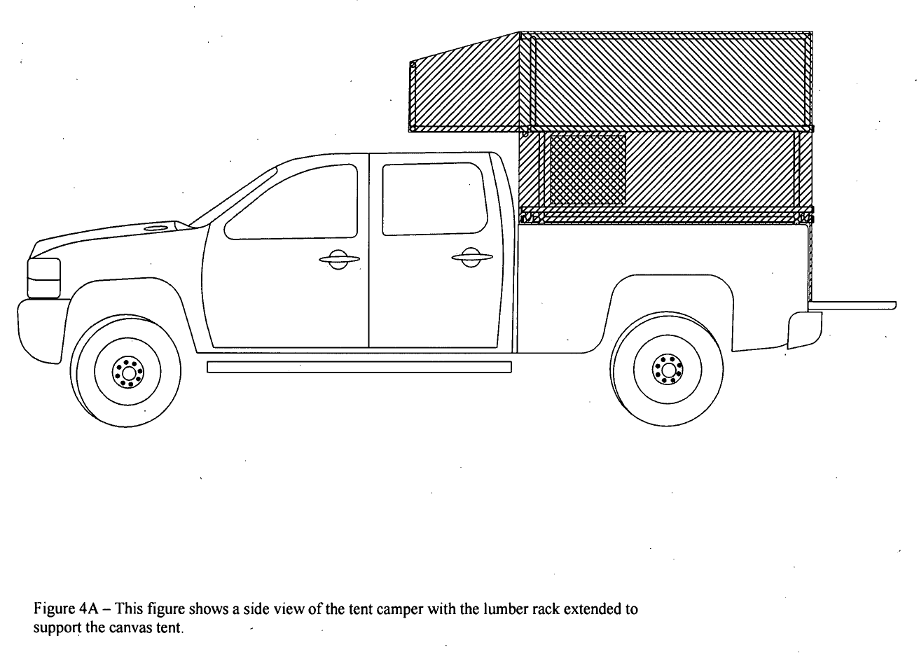

FIG. 5A—This figure shows the back view of the lumber rack in closed position as a lumber rack. The open position of the frame is shown with dashed lines and canvas tent in place.

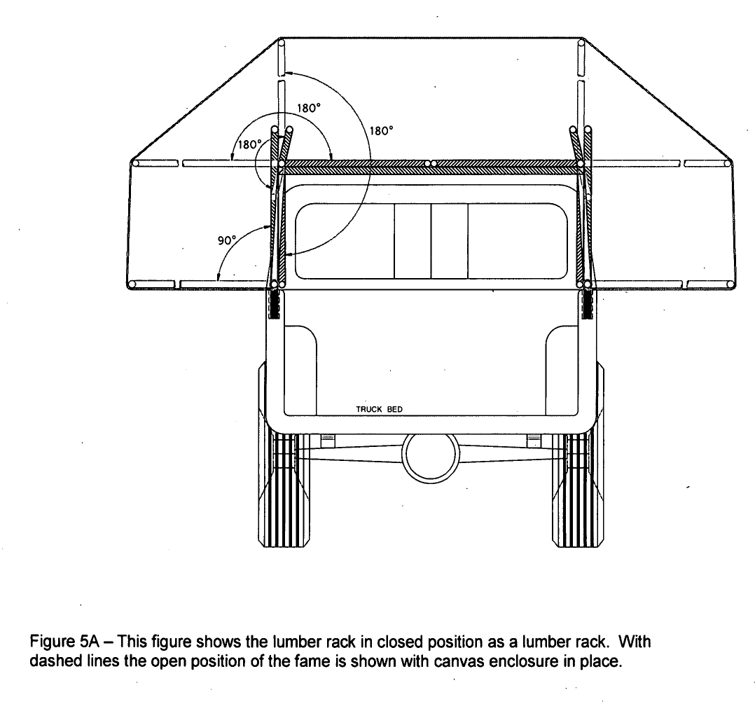

FIG. 6A—This figure shows a typical hinge assembly used at all locations where rotational connections are required.

FIG. 7A—This figure shows a perspective view of the frame fully extended without the tent cover installed.

### DETAILED DESCRIPTION OF THE INVENTION

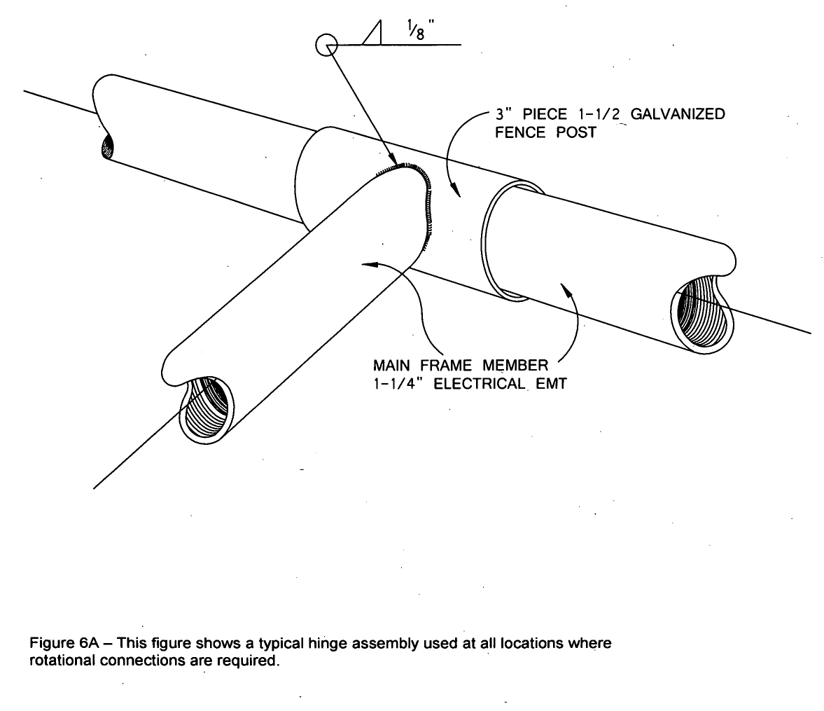

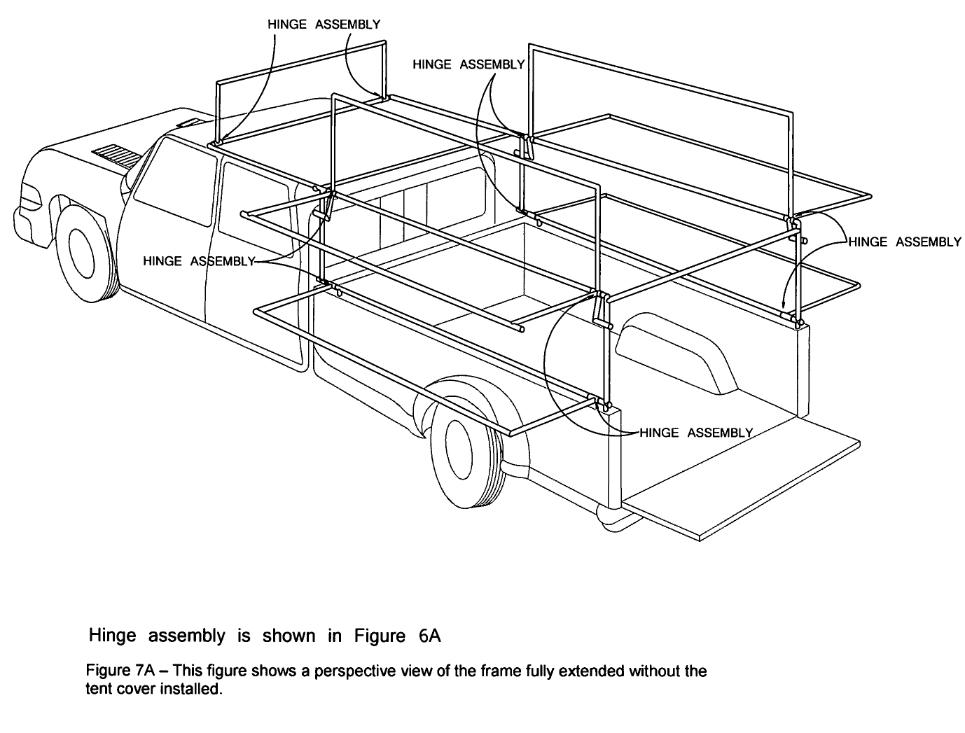

The convertible pickup tent camper/lumber rack is fabricated of 1-¼″ E.M.T. (galvanized electrical conduit) and 1-½″ chain link Fence posts (also galvanized). Aside from the tent cover, no other materials are required to fabricate the framework. The 1-½″ fence pipe fits neatly and snugly over the 1-¼″ E.M.T. pipe and is used to fabricate by cutting and welding the rotating hinge assemblies shown in FIG. 6A. The hinge assemblies are used wherever rotational movement is required to extend the framework for the tent cover and to retract it to the lumber rack position. FIG. 7A shows the complete framework in the extended position without the canvas tent cover in place. There are 10 hinge assemblies at various positions as indicated in the figure. The main assemblies of the convertible pickup tent camper/lumber rack are:
A. The fixed assembly
B. The main rotating assembly
C. The sleeping platforms
D. The front assembly
   Assemblies B, C and D are hinged to the fixed assembly which is mounted to the pickup by inserting the legs into the receptacles on the bed of the truck. The framework of each assembly is fabricated of 1-¼″ E.M.T. pipe and welded together at the joints. A mig welder was used to weld the framework together. The welds were then ground smooth and primed with zinc chromate primer and painted with silver metallic rust inhibiting paint.

The complete framework was taken to a custom canvas shop where specific instructions were given to fabricate the tent covering. The canvas surface of the tent is approximately 400 square feet or 44 square yards of canvas fabric. A large canvas tote bag is used to store the tent when not in use and can be hung on the frame across the front area of the truck bed behind the cab.

1. The subject matter of this invention is the framework of the lumber rack that folds out to form the framework of a pickup truck tent camper easily and rapidly without having to remove or add parts to the framework of the lumber rack and just as quickly and easily converting back to a pickup truck lumber rack for everyday use without removal and storage separate from the truck.
